(19) United States
(12) Patent Application Publication
(10) Pub. No.: US 2020/0388863 A1
(43) Pub. Date: Dec. 10, 2020

(54) FUEL CELL SYSTEM

(71) Applicant: HONDA MOTOR CO., LTD., Tokyo (JP)

(72) Inventor: Ryoichi Yoshitomi, Wako-shi (JP)

(21) Appl. No.: 16/879,816

(22) Filed: May 21, 2020

(30) Foreign Application Priority Data
May 31, 2019 (JP) 2019-102730

(51) Int. Cl. H01M 8/04119; H01M 8/04082; H01M 8/0662; H01M 8/04828

(52) U.S. Cl. CPC H01M 8/04164; H01M 8/04843; H01M 8/0687; H01M 8/04201

(57) ABSTRACT

A fuel cell system includes a fuel cell stack, and further includes, as piping structure, a supply pipe for supplying a cathode gas and a discharge pipe for discharging a cathode off gas. Further, the fuel cell system includes an expander, and a discharge side gas liquid separator disposed above the expander and configured to separate water from the cathode off gas. A water discharge pipe of the discharge side gas liquid separator is connected to a connector, of a discharge pipe, that is positioned on the downstream side of the expander, and the water discharge pipe extends downward obliquely toward the connector.

### CROSS-REFERENCE TO RELATED APPLICATION

This application is based upon and claims the benefit of priority from Japanese Patent Application No. 2019-102730 filed on May 31, 2019, the contents of which are incorporated herein by reference.

### BACKGROUND OF THE INVENTION

### Field of the Invention

The present invention relates to a fuel cell system for discharging gases and water from a fuel cell stack.

### Description of the Related Art

The fuel cell stack performs electric power generation by an anode gas such as hydrogen supplied from an anode gas system apparatus and a cathode gas such as air supplied from a cathode gas system apparatus. For example, Japanese Laid-Open Patent Publication No. 2012-164516 discloses a cathode gas system apparatus which compresses a cathode gas and supplies the cathode gas to a fuel cell stack, and includes an expander which expands cathode off gas discharged from the fuel cell stack.

### SUMMARY OF THE INVENTION

In this regard, as disclosed in Japanese Laid-Open Patent Publication 2012-164516, in such a structure where the cathode off gas channel has an expander, liquid such as water produced in the fuel cell stack and contained in the cathode off gas tends to flow into the expander easily. A large quantity of water that is retained in the expander may cause an operation failure of the expander. In particular, in a fuel cell vehicle having a structure where the expander is mounted on the lower side of the fuel cell stack in the gravity direction, there is a concern that water flows into the expander.

The present invention has been made taking the above problem into account, and an object of the present invention is to provide a fuel cell system which makes it possible to prevent water from flowing into an expander and to operate the expander stably.

In order to achieve the above object, according to an aspect of the present invention, a fuel cell system is provided. The fuel cell system includes a fuel cell stack, a supply pipe configured to supply a cathode gas to the fuel cell stack, a discharge pipe configured to discharge a cathode off gas from the fuel cell stack, an expander connected to the discharge pipe and configured to expand the cathode off gas, and a gas liquid separator provided at the discharge pipe positioned between the fuel cell stack and the expander, and configured to separate water from the cathode off gas and discharge the water. The gas liquid separator is disposed above the expander, and has a water discharge pipe configured to discharge the water. The water discharge pipe is connected to a connector part, of the discharge pipe, that is positioned on the downstream side of the expander, and the water discharge pipe extends obliquely downward from the gas liquid separator toward the connector part in a direction away from the expander.

In the present invention, it is possible to prevent water from flowing into the expander, and operate the expander stably.

The above and other objects features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a diagram showing a part of a fuel cell system according to a fuel cell system according to a first embodiment of the present invention;

FIG. 2 is a cross sectional side view showing a fuel cell stack and an auxiliary device case;

FIG. 3 is a side view showing piping structure of a cathode gas system apparatus of the fuel cell system in FIG. 1;

FIG. 4 is a side view showing flow of fluid in a cathode gas system apparatus;

FIG. 5 is a partial cross sectional view showing a state of a water discharge pipe in a case where acceleration toward the rear side of a fuel cell vehicle is applied to water;

FIG. 6 is a diagram partially showing a fuel cell system according to a second embodiment of the present invention; and

FIG. 7 is a side view showing piping structure of a cathode gas system apparatus of the fuel cell system in FIG. 6.

### DESCRIPTION OF THE PREFERRED EMBODIMENTS

Hereinafter, preferred embodiments of the present invention will be described with reference to the accompanying drawings;

### First Embodiment

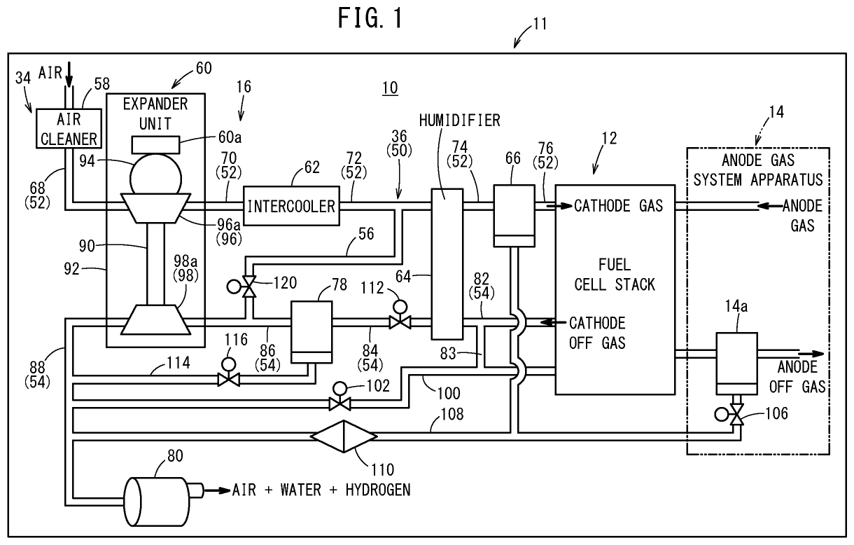

As shown in FIG. 1, a fuel cell system 10 according to a first embodiment of the present invention includes a fuel cell stack 12, an anode gas system apparatus 14, and a cathode gas system apparatus 16. The fuel cell stack 12 performs power generation based on an anode gas (fuel gas such as hydrogen) supplied from the anode gas system apparatus 14, and a cathode gas (oxygen-containing gas such as air) supplied from the cathode gas system apparatus 16. For example, the fuel cell system 10 is mounted in a motor room (not shown) of a fuel cell vehicle 11 (hereinafter simply referred to as the vehicle 11).

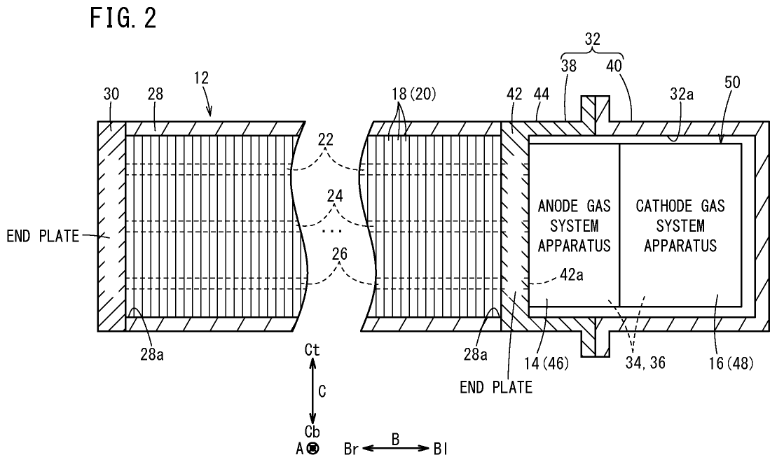

As shown in FIG. 2, the fuel cell stack 12 includes a plurality of power generation cells 18 for performing power generation by electrochemical reactions of the anode gas and the cathode gas. In a state where the fuel cell stack 12 is mounted in the vehicle 11, the plurality of power generation cells 18 are stacked together in a vehicle width direction (indicated by an arrow B) perpendicular to a vehicle length direction (front/back direction of the paper: direction indicated by the arrow A) with electrode surfaces being oriented in the vertical direction, whereby a stack body 20 is formed. It should be noted that the plurality of power generation cells 18 are stacked together in the vehicle length direction and/or the gravity direction (indicated by an arrow C).

Each of the power generation cells 18 includes a membrane electrode assembly (hereinafter referred to as the “MEA”) (not shown) and two separators (not shown) sandwiching the MEA. Outer ends of the separators of the adjacent power generation cells 18 are joined together by welding, brazing, crimping, etc. to form a one piece joined separator.

The MEA of the power generation cell 18 includes an electrolyte membrane (e.g., solid polymer electrolyte membrane (cation ion exchange membrane), an anode provided on one surface of the electrolyte membrane (not shown), and a cathode provided on the other surface of the electrolyte membrane (not shown). An anode flow field as a passage for the anode gas and a cathode flow field as a passage for the cathode gas are formed on surfaces of two separators facing the MEA. Further, a coolant flow field as a passage for a coolant is formed on surfaces of two separators that face each other. Each fluid flows through the anode gas flow field, the cathode gas flow field, the coolant flow field in the direction indicated by the arrow A.

Further, the plurality of power generation cells 18 (stack body 20) includes a plurality of fluid passages (anode gas passages 22, cathode gas passages 24, and coolant passages 26) for allowing the anode gas, the cathode gas, and the coolant to flow through the fluid passages on separator surfaces, respectively, in the stacking direction of the power generation cells 18 (indicated by the arrow B). In the stack body 20, the anode gas passage 22 is connected to the anode gas flow field, the cathode gas passage 24 is connected to the cathode gas flow field, and the coolant passage 26 is connected to the coolant flow field.

The anode gas supplied to the fuel cell stack 12 flows through the anode gas passage 22 (anode supply passage) into the anode gas flow field. The anode off gas used for power generation in the anode flows from the anode gas flow field into the anode gas passage 22 (anode discharge passage), and the anode off gas is discharged to the outside of the fuel cell stack 12.

The cathode gas supplied to the fuel cell stack 12 flows through the cathode gas passage 24 (cathode supply passage), and the cathode gas flows into the cathode gas flow field. The cathode off gas used for power generation in the cathode flows from the cathode gas flow field into the cathode gas passage 24 (cathode discharge passage), and the cathode off gas is discharged to the outside of the fuel cell stack 12.

The coolant supplied to the fuel cell stack 12 flows through the coolant passage (coolant supply passage) 26 into the coolant flow field. After the coolant cools the power generation cells 18, the coolant flows from the coolant flow field into the coolant passage 26 (coolant discharge passage), and the coolant is discharged to the outside of the fuel cell stack 12.

Further, the fuel cell stack 12 according to the embodiment of the present invention stores the stack body 20 in the stack case 28. Openings 28a are formed on both side surfaces of the stack case 28 in the stacking direction of the power generation cells 18 (indicated by the arrow B). The openings 28a communicate with the inner space of the stack case 28.

At one end of the stack body 20 in the direction indicated by the arrow B (indicated by an arrow Br), a terminal plate (not shown) is provided. An insulating plate (not shown) is provided outside the terminal plate. The terminal plate and the insulating plate are accommodated in the stack case 28. An end plate 30 is attached to a side of the stack case 28 in the direction indicated by the arrow Br so as to close the opening 28a of the stack case 28. The end plate 30 applies the tightening load to the power generation cells 18 in the stacking direction.

At the other end of the stack body 20 in the direction indicated by the arrow B (indicated by an arrow Bl), a terminal plate (not shown) is provided. An insulating plate (not shown) is provided outside the terminal plate. The terminal plate and the insulating plate are stored in the stack case 28. Further, an auxiliary device case 32 is attached to a side of the stack case 28 in the direction indicated by an arrow Bl in a manner to close the opening 28a.

The auxiliary device case 32 is a protection case for storing and protecting part of auxiliary devices 34 and pipes 36 of the fuel cell system 10, and the auxiliary device case 32 is fixed to the side of the stack case 28 in the direction indicate by the arrow Bl. The auxiliary device case 32 includes a first case member 38 having a recessed shape joined to the stack case 28, and a second case member 40 having a recessed shape joined to the first case member 38. A storage space 32a accommodating the auxiliary devices 34 is formed inside these members.

The first case member 38 includes an attachment wall 42 and a peripheral wall 44. The attachment wall 42 is joined to the stack case 28 using bolts, and separates the inner space of the stack case 28 and the storage space 32a of the auxiliary device case 32. The peripheral wall 44 is continuous with the outer edge of the attachment wall 42, and protrudes in the direction indicated by the arrow Bl. The attachment wall 42 has a function of an end plate for applying a tightening load to the stack body 20 of the power generation cells 18 in the stacking direction. The attachment wall 42 has holes 42a connected to the pipes 36 as fluid passages and which communicate respectively with the anode gas passages 22, the cathode gas passages 24, and the coolant passages 26 of the power generation cells 18.

Further, the auxiliary device case 32 contains therein a first space 46 and a second space 48. The first space 46 is positioned adjacent to the attachment wall 42, and mainly stores the anode gas system apparatus 14. The second space 48 is positioned adjacent to the first space 46, and mainly stores the cathode gas system apparatus 16. The piping structure 50 of the fuel cell system 10 according to the embodiment of the present invention chiefly relates to the cathode gas system apparatus 16. Part of the piping structure 50 is provided in the second space 48 of the auxiliary device case 32, and the remaining part of the piping structure 50 is provided outside the auxiliary device case 32.

Referring back to FIG. 1, next, overall structure of the cathode gas system apparatus 16 will be descried. As the pipes 36 of the piping structure 50, the cathode gas system apparatus 16 includes a supply pipe 52 for supplying an external cathode gas (air) to the fuel cell stack 12, and a discharge pipe 54 for discharging the cathode off gas from the fuel cell stack 12 to the outside. Further, the cathode gas system apparatus 16 includes a bypass pipe 56 connecting the supply pipe 52 and the discharge pipe 54, and which allows the cathode gas containing water (moisture) flowing through the supply pipe 52, to flow through the discharge pipe 54 without passing through the fuel cell stack 12.

The cathode gas system apparatus 16 includes a plurality of types of auxiliary devices 34 provided at positions in the middle of the supply pipe 52 and the discharge pipe 54. Specifically, the supply system of the cathode gas system apparatus 16 includes an air cleaner 58, a compressor 96 (expander unit 60) coupled to the expander 98, an intercooler 62, a humidifier 64, and a supply side gas liquid separator 66, which are arranged in this order, from the upstream side to the downstream side in the flow direction of the cathode gas on the supply pipe 52. Therefore, the supply pipe 52 includes a first supply pipe 68 connecting the air cleaner 58 and the compressor 96, a second supply pipe 70 connecting the compressor 96 and the intercooler 62, a third supply pipe 72 connecting the intercooler 62 and the humidifier 64, a fourth supply pipe 74 connecting the humidifier 64 and the supply side gas liquid separator 66, and a fifth supply pipe 76 connecting the supply side gas liquid separator 66 and the fuel cell stack 12.

Further, the discharge system of the cathode gas system apparatus 16 includes the humidifier 64, a discharge side gas liquid separator 78, the expander 98 (expander unit 60), and a dilution device 80, which are arranged in the order from the upstream side to the downstream side in the flow direction of the cathode off gas on the discharge pipe 54. Therefore, the discharge pipe 54 includes a first discharge pipe 82 connecting the fuel cell stack 12 and the humidifier 64, a second discharge pipe 84 connecting the humidifier 64 and the discharge side gas liquid separator 78, a third discharge pipe 86 connecting the discharge side gas liquid separator 78 and the expander 98, and a fourth discharge pipe 88 connecting the expander 98 and the dilution device 80.

The air cleaner 58 has therein a removal filter for removing foreign matters (dust, particles, water, etc.) which are present in the air taken from the outside, and for flowing the air to the first supply pipe 68.

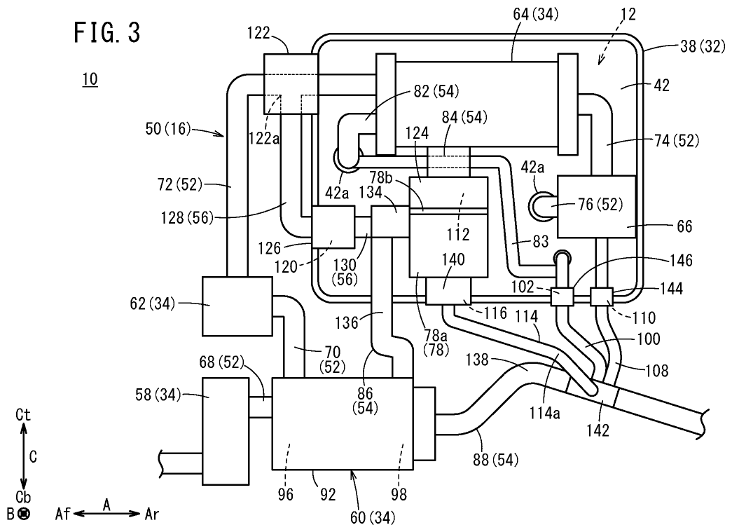

The expander unit 60 includes a stator (not shown) and a rotor 90 in a casing 92 (see also FIG. 1), and has a motor mechanism 94 which rotates the rotor 90 by electrical energy supplied from a power source (fuel cell stack 12, battery (not shown)) of the fuel cell system 10. The rotor 90 has a first fin 96a of the compressor 96 at one end, and a second fin 98a of the expander 98 at the other end. Further, the casing 92 includes a supply space of the compressor 96 connected to the first and second supply pipes 68, 70 and containing the first fin 96a, and a discharge space of the expander 98 connected to the third and fourth discharge pipes 86, 88 and storing the second fin 98a independently from each other. As shown in FIG. 3, the third discharge pipe 86 is connected to an outer circumferential surface of the cylindrical casing 92, and the fourth discharge pipe 88 is connected to a central part of one end of the cylindrical casing 92.

In the expander unit 60, as shown in FIG. 1, the rotation speed of the rotor 90 is adjusted based on power supply by the inverter device (Power Drive Unit: PDU 60a). The cathode gas system apparatus 16 suctions the cathode gas from the first supply pipe 68 of the supply pipe 52 by rotation of the rotor 90 (first fin 96a) and discharges the compressed cathode gas (compressed air) to the second supply pipe 70.

The intercooler 62 cools cathode gas that flows from the compressor 96 into the intercooler 62 through the second supply pipe 70, and discharges the cathode gas to the third supply pipe 72. The intercooler 62 may adopt one of, or both of the air cooling type and the water cooling type. One end of the above described bypass pipe 56 is connected to the third supply pipe 72.

The humidifier 64 humidifies the cathode gas supplied from the third supply pipe 72 by utilizing the cathode off gas of the discharge pipe 54. That is, the cathode off gas contains water (produced water) produced in power generation of the fuel cell stack 12, and the humidifier 64 moves this water to the cathode gas as necessary, and discharges the water to the fourth supply pipe 74.

The humidified cathode gas is supplied to the supply side gas liquid separator 66. The supply side gas liquid separator 66 separates water (moisture) from the cathode gas in a manner that the cathode gas contains a suitable moisture, and discharges the cathode gas to the fifth supply pipe 76. The fifth supply pipe 76 is connected to the hole 42a (see FIG. 2) communicating with the cathode gas passage 24 of the fuel cell stack 12. The cathode gas is supplied to the fuel cell stack 12.

Further, the anode gas system apparatus 14 of the fuel cell system 10 includes a valve 106 which opens/closes the channel for the anode off gas. That is, the fuel cell system 10 opens/closes the valve 106 at suitable timing to discharge the anode off gas (water and the hydrogen gas) that flowed into the gas liquid separator 14a of the anode gas system apparatus 14, to the discharge system of the cathode gas system apparatus 16.

Further, a water discharge pipe 108 is connected to the supply side gas liquid separator 66. This water discharge pipe 108 is connected to the fourth discharge pipe 88 along a predetermined path. An orifice 110 for adjusting the quantity of water discharged through the water discharge pipe 108 is provided at a position in the water discharge pipe 108.

On the other hand, as described above, the cathode off gas containing the water produced during power generation of the fuel cell stack 12 is discharged into the first discharge pipe 82 of the cathode gas system apparatus 16. This cathode off gas flows from the first discharge pipe 82 into the humidifier 64, and humidifies the cathode gas on the supply side. The water which has not been used for humidification and the cathode off gas are discharged into the second discharge pipe 84 connected to the downstream side of the humidifier 64.

Further, in the fuel cell system 10, a drain discharge pipe 100 is provided between the stack case 28 and the fourth discharge pipe 88, for discharging the water produced as a result of reactions in the fuel cell stack 12 from the cathode gas passage 24. A valve 102 for opening/closing the channel of the drain discharge pipe 100 is provided at a position in the middle of the drain discharge pipe 100.

Further, a branch pipe 83 connecting the first discharge pipe 82 and the drain discharge pipe 100 is provided at a position in the middle of the first discharge pipe 82. That is, when the valve 102 is in an open state, some of the water flowing through the first discharge pipe 82 flows from the upstream side of the humidifier 64 into the branch pipe 83, and the water is discharged into the fourth discharge pipe 88.

On the other hand, the second discharge pipe 84 connected to the downstream side of the humidifier 64 is provided with a back pressure valve 112 for adjusting the pressure of the cathode off gas of the discharge pipe 54. For example, the back pressure valve 112 is in the form of a butterfly valve. Based on the power generation electrical current value required for the fuel cell stack 12, the pressure value and/or the flow rate value detected by the pressure sensor (not shown) and/or the flow rate sensor (not shown), the opening degree of the back pressure valve 112 is controlled.

The cathode gas flows from the second discharge pipe 84 into the discharge side gas liquid separator 78. The discharge side gas liquid separator 78 separates the gas (chiefly the air) and the liquid (chiefly the water), and removes water (moisture) to thereby decrease the water concentration in the cathode off gas. In addition to the second and third discharge pipes 84, 86, the water discharge pipe 114 is connected to the discharge side gas liquid separator 78. The water discharge pipe 114 is connected to the fourth discharge pipe 88 extended from the expander unit 60. Further, a valve 116 for opening/closing the internal channel is provided in the water discharge pipe 114.

In a state where the gas contains as little water as possible, the discharge side gas liquid separator 78 discharges the gas (cathode off gas) into the third discharge pipe 86. Therefore, for example, the discharge side gas liquid separator 78 is in the form of a tubular body 78a having a suitable depth in the gravity direction (see also FIG. 3). The third discharge pipe 86 allows this cathode off gas to flow therethrough to the expander 98.

The second fin 98a of the expander 98 is rotated by the cathode off gas to transmit fluid energy of the cathode off gas to the compressor 96. That is, the expander 98 functions as an apparatus for reproducing the fluid energy. Further, the expander 98 lowers the pressure of the cathode off gas by expanding the cathode off gas as a result of collection of the fluid energy, and discharges this cathode off gas into the fourth discharge pipe 88.

The other end of the bypass pipe 56 is connected to a position in the middle of the third discharge pipe 86. The bypass pipe 56 is provided with a bypass valve 120 that opens and closes the channel inside the bypass pipe 56. The bypass valve 120 is suitably opened and closed under control of the ECU of the fuel cell system 10 for allowing the cathode gas of the supply pipe 52 to flow into the discharge pipe 54 and then discharging the cathode gas through the discharge pipe 54.

The dilution device 80 contains therein a filter (not shown), and gas and liquid which have flowed through the fourth discharge pipe 88 flows into the dilution device 80. The water discharge pipes 108, 114, and a drain discharge pipe 100 are connected to the above described fourth discharge pipe 88. Therefore, the dilution device 80 dilutes hydrogen, and brings the gas and the liquid into a clean state, and discharges the gas and the liquid to the outside of the vehicle 11.

In the cathode gas system apparatus 16 having the above structure, a large quantity of water is present on the upstream side of the discharge pipe 54 where the cathode off gas flows. In this regard, with a structure where the expander 98 is connected to the discharge pipe 54, in a case that a large quantity of the water in the cathode off gas flows into the casing 92 (discharge side space), an operation failure may occur in the expander 98. Further, assuming that the temperature around the vehicle 11 becomes low (not more than the freezing temperature) and then the water that has entered the expander 98 freezes, malfunction may occur in the expander 98.

Therefore, in a state where the piping structure 50 of the fuel cell system 10 is mounted in the vehicle 11 (actual structure), it is possible to avoid the situation where the water flows into the expander 98. Hereinafter, the actual system structure will be described in detail with reference to FIG. 3. It should be noted that, hereinafter, the position and the direction of each structure will be described, based on indications of arrows in FIG. 3 (or arrows in FIG. 2). The direction indicated by the arrow A shown in the illustrated example is a front/rear direction of the vehicle 11. The direction indicated by the arrow Af corresponds to the front direction of the vehicle 11, and the direction indicated by the arrow Ar corresponds to the rear direction of the vehicle 11. The direction indicated by the arrow B in the illustrated example is a left/right direction of the vehicle 11, and the direction indicated by the arrow Bl corresponds to the left direction of the vehicle 11, while the direction indicated by the arrow Br corresponds to the right direction of the vehicle 11. The direction indicated by the arrow C in the illustrated example is the upper/lower direction (gravity direction) of the vehicle 11, and the arrow Ct corresponds to the upper direction of the vehicle 11, while the arrow Cb corresponds to the lower direction of the vehicle 11.

FIG. 3 is a side view showing a piping structure 50 of a cathode gas system apparatus 16 (fuel cell system 10) in a state where the second case member 40 is removed from the first case member 38 of the auxiliary device case 32. It should be noted that the cathode gas system apparatus 16 is provided at a position outside and adjacent to the anode gas system apparatus 14 as described above (see also FIG. 2). Though not illustrated in FIG. 3, the auxiliary device 34 and the pipe 36 of the anode gas system apparatus 14 are partially provided on the back side of the cathode gas system apparatus 16.

In the actual system structure, the fuel cell stack 12 is stored in a motor room by a mounting structure (not shown). The expander unit 60 is spaced from the fuel cell stack 12 on the lower side of the fuel cell stack 12 in the gravity direction (indicated by the arrow Cb), and fixed at a position overlapped with a portion of the fuel cell stack 12 that lies on a side of the arrow Af. The air cleaner 58 and the intercooler 62 are provided around the expander unit 60. That is, the auxiliary devices 34 (the air cleaner 58, the expander unit 60, and the intercooler 62) on the upstream side of the supply system of the cathode gas system apparatus 16 are provided outside the auxiliary device case 32.

On the other hand, the humidifier 64 of the cathode gas system apparatus 16 is provided on the lateral side (upper side inside the auxiliary device case 32) of the fuel cell stack 12. Further, the supply side gas liquid separator 66 and the discharge side gas liquid separator 78 are provided on the lower side of the humidifier 64 in the gravity direction (indicated by the arrow Cb) (lower side in the auxiliary device case 32). The supply side gas liquid separator 66 is disposed on a side of the auxiliary device case 32 indicated by the arrow Ar, and the discharge side gas liquid separator 78 is disposed on a side of the auxiliary device case 32 indicated by the arrow Af. That is, the humidifier 64 and the two gas liquid separators 66, 78 of the cathode gas system apparatus 16 are stored in the auxiliary device case 32.

The supply pipe 52 and the discharge pipe 54 of the cathode gas system apparatus 16 couples the auxiliary devices 34 disposed as described above so as to have the connection relationship shown in FIG. 1. Specifically, the first supply pipe 68 connects an upper end of the air cleaner 58 and a side of the casing 92 of the expander unit 60 in the direction indicated by the arrow Af. The second supply pipe 70 connects an upper part of the expander unit 60 and a side of the intercooler 62 indicated by the arrow Ar.

The third supply pipe 72 connects an upper part of the intercooler 62 and a side of the humidifier 64 indicated by the arrow Af. The third supply pipe 72 includes a connector member 122 fixed to the auxiliary device case 32 in a manner to penetrate between the inside and the outside of the auxiliary device case 32. The connector member 122 is in the form of a T type connector or a Y type connector having a branch portion 122a connected to the bypass pipe 56 outside the auxiliary device case 32.

The fourth supply pipe 74 connects a side of the humidifier 64 in the direction indicated by the arrow Ar and an upper portion of the supply side gas liquid separator 66. Further, the fifth supply pipe 76 connecting the supply side gas liquid separator 66 and the fuel cell stack 12 is connected to a hole 42a of the attachment wall 42.

On the other hand, the first discharge pipe 82 connects a side of the fuel cell stack 12 that lies on the arrow Af side and at an intermediate part thereof in the direction indicated by the arrow C, and a side of the humidifier 64 in the direction indicated by the arrow Af. The branch pipe 83 branched from the first discharge pipe 82 extends in the direction indicated by the arrow Ar, and then the branch pipe 83 extends downward and is connected to the drain discharge pipe 100. The second discharge pipe 84 protrudes downward from the lower side of a tubular side surface of the humidifier 64, and is connected to an upper end 78b of the discharge side gas liquid separator 78. A back pressure valve 112 is provided inside a joint 124 provided at a position connecting the second discharge pipe 84 and the discharge side gas liquid separator 78.

The discharge side gas liquid separator 78 is formed to have a tubular body 78a extending downward in the direction indicated by the arrow C, from the upper end 78b connected to the second discharge pipe 84, by a predetermined length. Water separated from the cathode off gas is stored in the lower part of the tubular body 78a, and the gas separated from the water flows through the upper end 78b of the discharge side gas liquid separator 78. The third discharge pipe 86 and the bypass pipe 56 are connected to the upper end 78b.

The bypass pipe 56 includes an outer pipe 128 extending outside of the auxiliary device case 32 from the connector member 122 in the direction indicated by the arrow Cb, the outer pipe being connected to a valve equipped connector member 126 fixed to a lower part of the auxiliary device case 32, and an inner pipe 130 extending from the valve equipped connector member 126 toward the upper end 78b inside the auxiliary device case 32. A bypass valve 120 is provided inside the valve equipped connector member 126.

The third discharge pipe 86 includes a connector member 134 fixed to the upper end 78b and fixed to the auxiliary device case 32, and an outer pipe 136 connected to the connector member 134 and which extends in the direction indicated by the arrow Cb outside the auxiliary device case 32 and is connected to the expander unit 60. The outer pipe 136 is connected to a side of the casing 92 of the expander unit 60 in the direction indicated by the arrow Ar.

Further, the fourth discharge pipe 88 extends in the direction indicated by the arrow Ar, from an end of the expander unit 60 in the direction indicated by the arrow Ar.

This fourth discharge pipe 88 extends from the casing 92 of the expander unit 60 upward obliquely by a predetermined length, up to a curved portion 138 formed in the fourth discharge pipe 88. Then, the fourth discharge pipe 88 is curved at the curved portion 138, and extends in the direction indicated by the arrow Ar and downward obliquely again, and the fourth discharge pipe 88 is connected to the dilution device 80 (see FIG. 1). For example, the dilution device 80 is provided on a side of the vehicle 11 indicated by the arrow Ar.

The water discharge pipe 114 of the discharge side gas liquid separator 78 is fixed to the auxiliary device case 32, and connected to the lower end of the tubular body 78a through the valve equipped connector member 140 having therein a valve 116. This water discharge pipe 114 is exposed to the outside of the auxiliary device case 32, and extends in the direction of the arrow Ar and downward obliquely gently. Further, the water discharge pipe 114 is curved slightly at its intermediate position 114a so as to be curved downward at a sharp angle, and is then connected to the connector 142 of the fourth discharge pipe 88. The connector 142 of the fourth discharge pipe 88 is positioned remotely from the curved portion 138 of the fourth discharge pipe 88 in the direction indicated by the arrow Ar (toward the downstream side) (from the expander unit 60).

Further, the water discharge pipe 108 of the supply side gas liquid separator 66 is connected to the lower end of the supply side gas liquid separator 66 through an orifice equipped connector member 144 attached to the auxiliary device case 32. The water discharge pipe 108 is exposed to the outside of the auxiliary device case 32 and extends downward. The water discharge pipe 108 is connected to the connector 142 of the fourth discharge pipe 88. Further, the drain discharge pipe 100 protrudes from the hole 42a on a side of the fuel cell stack 12 in the direction indicated by the arrow Cb, and extends downward through the valve equipped connector member 146 having the valve 102. The drain discharge pipe 100 is connected to the connector 142. For example, it is preferable that the connector 142 is in the form of a manifold having a branch portion by which two pipes 36 (the water discharge pipe 108 and the water discharge pipe 114) can be connected to the main pipe 36 (fourth discharge pipe 88).

The piping structure 50 of the fuel cell system 10 according to the embodiment of the present invention basically has the above structure. Hereinafter, operation of the piping structure 50 will be described.

As shown in FIG. 1, in the fuel cell system 10, during normal operation (during power generation of the fuel cell stack 12), the anode gas system apparatus 14 supplies an anode gas to the fuel cell stack 12, and discharges an anode off gas from the fuel cell stack 12. Further, in the fuel cell system 10, during power generation of the fuel cell stack 12, the cathode gas system apparatus 16 supplies the cathode gas to the fuel cell stack 12, and discharges the cathode off gas from the fuel cell stack 12.

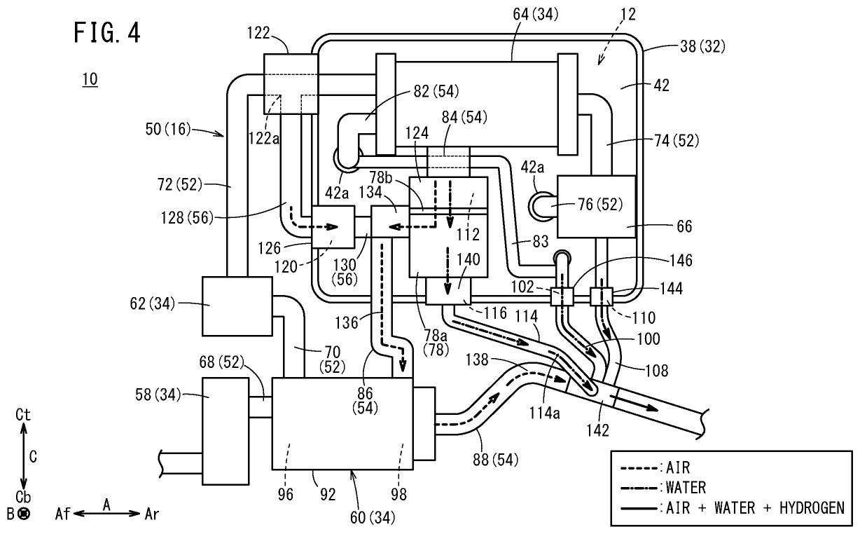

Specifically, as shown in FIGS. 1 and 4, the cathode gas system apparatus 16 causes the cathode gas to flow into the first supply pipe 68 through the air cleaner 58. The cathode gas is pressurized by driving the compressor 96, and supplied to the humidifier 64 through the second supply pipe 70, the intercooler 62, and the third supply pipe 72. Then, when the cathode gas is humidified at the humidifier 64, the cathode gas is supplied to the fuel cell stack 12 through the fourth supply pipe 74, the supply side gas liquid separator 66, and the fifth supply pipe 76.

The cathode gas is consumed in power generation of the fuel cell stack 12, and as a result, the cathode gas contains a large quantity of water. The cathode gas containing the large quantity of water is referred to as the cathode off gas. The cathode off gas is discharged from the fuel cell stack 12 into the first discharge pipe 82. When the cathode off gas flows from the first discharge pipe 82 into the humidifier 64, the cathode off gas humidifies the cathode gas to be supplied, by utilizing the water (moisture) contained in the cathode off gas, and the cathode off gas containing the remaining water is discharged into the second discharge pipe 84.

Further, the cathode off gas flows from the second discharge pipe 84 into the discharge side gas liquid separator 78, and the cathode off gas is separated by the discharge side gas liquid separator 78 into the gas and liquid (liquid water). The cathode off gas from which the liquid water has been separated by the discharge side gas liquid separator 78 flows into an expander 98 through the third discharge pipe 86 connected to the upper end 78b of the discharge side gas liquid separator 78. The quantity of the liquid water contained in the cathode off gas that is discharged to the downstream side of the discharge side gas liquid separator 78 is small. Therefore, it is possible to prevent operation failures from occurring due to the flow of the liquid water into the expander 98. Therefore, it is possible to maintain a suitable operating state of the expander 98.

Further, the discharge side gas liquid separator 78 discharges the liquid water separated from the cathode off gas through the water discharge pipe 114 connected to the lower end of the tubular body 78a. In this regard, the water discharge pipe 114 extends from the discharge side gas liquid separator 78 in the direction indicated by the arrow

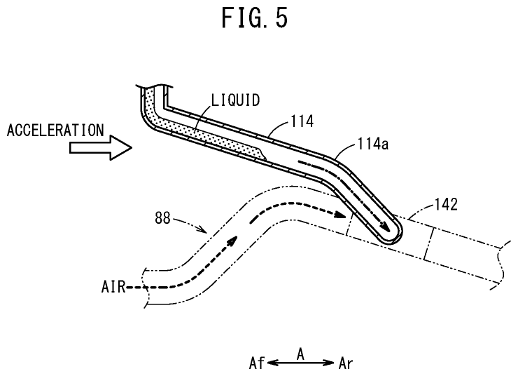

Ar (in the direction away from the expander 98) so as to be inclined downward obliquely. Therefore, the liquid water can flow along the inclination of the water discharge pipe 114 by its own weight without stagnation, and the liquid water is merged with the cathode off gas in the connector 142 of the fourth discharge pipe 88. Further, as shown in FIG. 5, the liquid water is subjected to acceleration at the time of forward movement of the vehicle 11. Thus, the liquid water moves smoothly in the direction of the arrow Ar inside the water discharge pipe 114 extending in the direction indicated by the arrow Ar, and the liquid water is merged into the fourth discharge pipe 88. Therefore, it is possible to discharge the liquid water from the discharge side gas liquid separator 78 suitably.

The fourth discharge pipe 88 extends, at first, from the expander 98 in the direction indicated by the arrow Ar and upward obliquely, and then extends from the curved portion 138 in the direction indicated by the arrow Ar and downward obliquely. The liquid water which flows through the water discharge pipe 114 into the fourth discharge pipe 88 is merged at the connector 142 on the rear side of the curved portion 138. In the structure, backflow of the liquid water toward the expander 98 is prevented. It should be noted that the liquid water and/or the hydrogen (anode off gas) from the supply side gas liquid separator 66 also flows into the connector 142 of the fourth discharge pipe 88 though the water discharge pipe 108 as described above. It is possible to prevent the backflow of this liquid water toward the expander 98 as well. Then, the fourth discharge pipe 88 allows the cathode off gas (air), water, and the anode off gas (hydrogen) to flow through the discharge channel on the rear side of the connector 142. Then, the cathode off gas (air), the air, and the anode off gas (hydrogen) are discharged to the outside of the vehicle 11 through the dilution device 80.

### Second Embodiment

Next, a fuel cell system 10A according to a second embodiment of the present invention will be described. In the following description, the structure or functions of the fuel cell system 10A that are identical to those of the fuel cell system 10 are labeled with the same reference numerals, and description thereof is omitted.

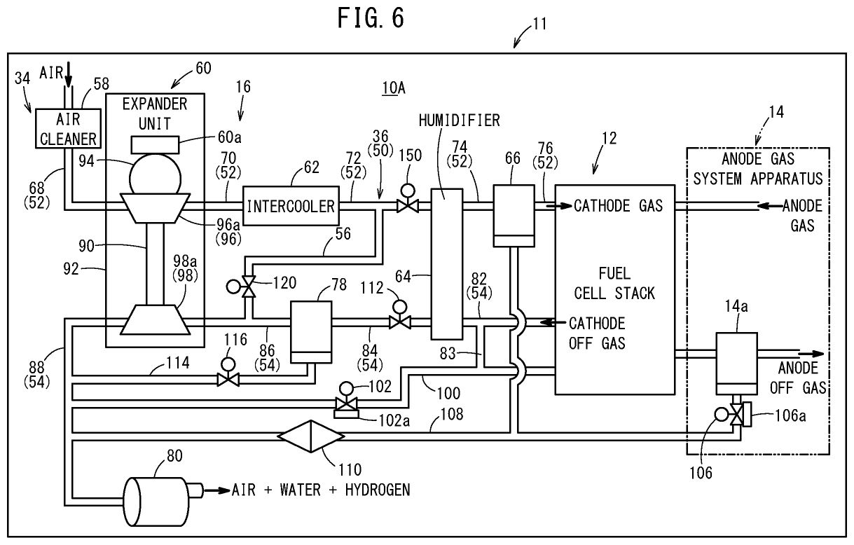

As shown in FIG. 6, the fuel cell system 10A is different from the fuel cell system 10 in that the fuel cell system 10A has a supply side valve 150 at a position in the middle of the supply pipe 52 (third supply pipe 72). The supply side valve 150 is opened and closed under the control of the ECU (not shown), to thereby supply or stop supply of the cathode gas from the supply pipe 52 to the fuel cell stack 12.

Further, the fuel cell system 10A has heaters 102a, 106a respectively at a valve 102 and a valve 106 which are disposed at positions (a drain discharge pipe 100, a water discharge pipe 108 of the anode gas system apparatus 14) where the water flows. The heaters 102a, 106a heat the valves 102, 106 under the low temperature environment to thereby avoid operation failures (occlusion, etc.) of the valves 102, 106 caused by freezing of the water.

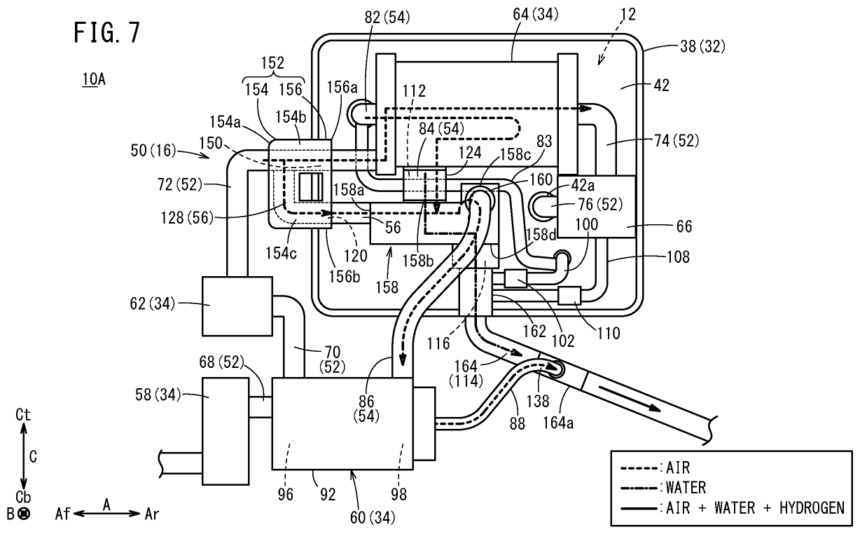

Further, as shown in FIG. 7, the fuel cell system 10A includes a unit structural body 152 forming a branch part (bifurcation) of the third supply pipe 72 and the bypass pipe 56. The unit structural body 152 includes an outer fixing manifold 154 provided outside the auxiliary device case 32, and a valve unit 156 coupled to the outer fixing manifold 154 and stored inside the auxiliary device case 32.

The outer fixing manifold 154 includes an upper end 154a to which a flexible pipe of the third supply pipe 72 is connected. The outer fixing manifold 154 further includes a first pipe 154b extending from the upper end 154a in the direction indicated by an arrow Ar and a second pipe 154c extending downward from the upper end 154a by a short length and then further extending in the direction indicated by the arrow Ar.

The valve unit 156 includes a first tubular portion 156a and a second tubular portion 156b. The first tubular portion 156a extends in the direction of the arrow A by a short length, and the first pipe 154b is connected to the first tubular portion 156a. Likewise, the second tubular portion 156b extends in the direction of the arrow A by a short length, and the second pipe 154c is connected to the second tubular portion 156b. The first tubular portion 156a and the second tubular portion 156b are arranged side by side in the direction indicated by the arrow C, and are coupled together. Further, a supply side valve 150 is provided inside the first tubular portion 156a, and a bypass valve 120 is provided inside the second tubular portion 156b.

The first tubular portion 156a is connected to the humidifier 64 provided on a side of the valve unit 156 in the direction indicated by the arrow Ar, and the second tubular portion 156b is connected to the discharge side gas liquid separator 158 provide on the rear side in the direction indicated by the arrow A. That is, when the cathode gas flows through the third supply pipe 72 on the downstream side of the intercooler 62, in a state where the supply side valve 150 is opened, the cathode gas flows through the first pipe 154b and the first tubular portion 156a, and then flows into the humidifier 64. Further, in a state where the bypass valve 120 is opened, the cathode gas flows through the second pipe 154c and the second tubular portion 156b, and then flows into the discharge side gas liquid separator 158.

The discharge side gas liquid separator 158 is positioned closer to an arrow Cb side than the humidifier 64 inside the auxiliary device case 32, and extends in the direction indicated by the arrow A. The discharge side gas liquid separator 158 includes a supply system port 158a connected to the above second tubular portion 156b, and a discharge system port 158b connected to the second discharge pipe 84 provided on the downstream side of the humidifier 64. The discharge system port 158b is connected to a joint 124, which is connected to the lower part of the humidifier 64 and which has therein a back pressure valve 112.

The discharge side gas liquid separator 158 separates the cathode off gas of the second discharge pipe 84 in the internal space extending in the direction of the arrow A into gas and liquid and removes water (moisture), to thereby reduce water concentration in the cathode off gas. The discharge side gas liquid separator 158 has, at an end thereof in the direction of the arrow Ar, a gas discharge port 158c for discharging the gas (air, hydrogen, etc.), and a liquid discharge port 158d for discharging the separated liquid (liquid water).

The gas discharge port 158c protrudes upward from the body part of the discharge side gas liquid separator 158, and provided with the fixing connector 160 to which one end of the third discharge pipe 86 is connected. The third discharge pipe 86 extends downward from the discharge side gas liquid separator 158, and the other end of the third discharge pipe 86 is connected to the expander 98. That is, the discharge side gas liquid separator 158 discharges the gas from the upwardly-protruding gas discharge port 158c into the third discharge pipe 86 to thereby decrease the water (liquid water) from the cathode off gas.

The liquid discharge port 158d is provided on a side of the discharge side gas liquid separator 158 in the direction indicated by the arrow Ar, and connected to the to the water discharge connector 162 through the valve 116. The water discharge connector 162 extends downward and to the outside of the auxiliary device case 32, and the water discharge pipe 114 is connected to the water discharge connector 162. Further, a water discharge pipe 108 and a drain discharge pipe 100 are connected to the water discharge connector 162. The water discharge pipe 108 is connected to the supply side gas liquid separator 66. The drain discharge pipe 100 is connected to a branch pipe 83.

The water discharge pipe 114 is made of a hard pipe (resin pipe, metal pipe) 164 coupled to the lower end of the water discharge connector 162. The hard pipe 164 (water discharge pipe 114) extends from the connecting portion of the water discharge connector 162 in the direction indicated by the arrow Ar, so as to be inclined downward gently. At a position in the middle of the hard pipe 164 which extends downward obliquely, a connector 164a is provided. A fourth discharge pipe 88 is connected to the connector 164a on the side indicated by an arrow Bl (see FIG. 2: vehicle width direction). The fourth discharge pipe 88 obliquely extends from the expander 98 in the direction of the arrow Ar and upward (in the direction of the arrow Ct), passes through a curved portion 138 positioned slightly above the connector 164a, further extends in the direction of the arrow Ar and downward, and is then connected to the connector 164a.

The fuel cell system 10A according to the second embodiment basically has the above structure. Hereafter, operation and advantages of the fuel cell system 10A will be described. In the cathode gas system apparatus 16 of the fuel cell system 10A, the cathode gas is pressurized based on operation of the compressor 96, whereby the cathode gas flows through the third supply pipe 72 in the direction indicated by the arrow Ct and flows into the unit structural body 152. In the unit structural body 152, when the supply side valve 150 is opened, the cathode gas is supplied to the humidifier 64 through the first pipe 154b and the first tubular portion 156a. After the cathode gas is humidified by the humidifier 64, the cathode gas is supplied from the humidifier 64 to the fuel cell stack 12 through the supply side gas liquid separator 66, etc.

The cathode off gas consumed in power generation of the fuel cell stack 12 flows through the first discharge pipe 82, and flows into the humidifier 64. In the humidifier 64, the cathode off gas humidifies the cathode gas to be supplied, by utilizing water (moisture) contained in the cathode off gas, and the cathode off gas containing the remaining water is discharged directly, and then the cathode off gas flows into the discharge side gas liquid separator 158 through the discharge system port 158b.

Further, in a case where the bypass valve 120 is opened in the unit structural body 152, the cathode gas is supplied through the second pipe 154c, the second tubular portion 156b, and the supply system port 158a into the discharge side gas liquid separator 158. In the discharge side gas liquid separator 158, the cathode gas or the cathode off gas moves in the direction indicated by the arrow Ar, and the gas and the liquid water are separated from each other during the movement. Then, the gas is discharged through a gas discharge port 158c at an upper position of the discharge side gas liquid separator 158 and a fixing connector 160, and the gas then flows along the third discharge pipe 86 in the direction indicated by the arrow Cb toward the expander 98. Since the quantity of the liquid water contained in the gas is small, it is possible to prevent the liquid water from flowing into the expander 98 and thus avoid malfunction of the expander. Therefore, it is possible to maintain a suitable operating state.

In the meanwhile, the liquid water from the discharge side gas liquid separator 158 flows into the water discharge connector 162, through the liquid discharge port 158d on the rear side of the discharge side gas liquid separator 158, and the liquid water is discharged from the water discharge connector 162 to the hard pipe 164. The inclination angle of the hard pipe 164 is fixed (the hard pipe 164 is not flexible). Therefore, the liquid water can be discharged smoothly. Then, in the connector 164a on the hard pipe 164 where the liquid water flows, the liquid water is merged with gas that is discharged from the expander 98.

In this regard, the fourth discharge pipe 88 extending from the expander 98 extends rearward in the direction indicated by the arrow A and obliquely in the direction indicated by the arrow Ct. The fourth discharge pipe 88 is connected to the connector 164a of the hard pipe 164 through the curved portion 138. The liquid water separated from the cathode off gas flows in the hard pipe 164 obliquely downward by its own weight. Therefore, movement of the liquid toward the fourth discharge pipe 88 (i.e., backflow toward the expander 98) is prevented.

The fuel cell system 10 according to the present invention offers the following advantages.

In the fuel cell systems 10, 10A, the water discharge pipe 114 of the gas liquid separator (discharge side gas liquid separators 78, 158) is connected to the connector part (connectors 142, 164a), of the discharge pipe 54, that is positioned on the downstream side of the expander 98, and the water discharge pipe 114 extends obliquely downward from the discharge side gas liquid separator 78, 158 toward the connector 142, 164a in the direction away from the expander 98. In the structure, it is possible to prevent water from flowing into the expander 98. That is, the discharge side gas liquid separator 78, 158 separates water from the cathode off gas at a position above the expander 98, and causes the separated water to flow stably into the discharge pipe 54 (fourth discharge pipe 88) on the downstream side of the expander 98, through the water discharge pipe 114 inclined obliquely downward. The cathode off gas flows from the expander 98 into the fourth discharge pipe 88, and the water which has flowed from the water discharge pipe 114 to the fourth discharge pipe 88 is discharged to the downstream side of the discharge pipe 54 without causing any backflow. Therefore, in the fuel cell system 10, 10A, the cathode off gas containing little water flows from the discharge side gas liquid separator 78, 158 into the expander 98. Therefore, it is possible to operate the expander 98 stably. Therefore, it is possible to significantly increase the durability of the expander 98, and suppress damage to the expander due to freezing, etc.

Further, preferably, the discharge pipe 54 (third discharge pipe 86) between the expander 98 and the discharge side gas liquid separator 78, 158 is connected to the upper end 78b (gas discharged port 158c) of the discharge side gas liquid separator 78. In the structure, since the discharge side gas liquid separator 78, 158 stores the water separated from the cathode off gas, based on its own weight of the water, on the lower side in the discharge side gas liquid separator, it is possible to reliably discharge the cathode off gas which does not contain water, into the discharge pipe 54.

Further, preferably, the bypass pipe 56 is provided between the supply pipe 52 and the discharge pipe 54, for allowing the cathode gas to flow from the supply pipe 52 to the discharge pipe 54, and the bypass pipe 56 is connected to the discharge side gas liquid separator 78, 158. With the structure, in the fuel cell system 10 (cathode gas system apparatus 16), since the bypassed cathode gas passes through the discharge side gas liquid separator 78, 158, it is possible to significantly reduce the water component contained in the gas flowing through the expander 98.

Further, a portion where the supply pipe 52 and the bypass pipe 56 are connected together comprises the unit structural body 152, and the unit structural body 152 includes a portion configured to serve as the supply pipe 52 that causes the cathode gas to flow toward the fuel cell stack 12, and a portion configured to serve as the bypass pipe 56 connected to the gas liquid separator 158. In this manner, since the unit structural body 152 is provided, in the fuel cell system 10A, the branch portion of the supply pipe 52 has more simple structure, and the cathode gas is caused to flow to the discharge side gas liquid separator 158. Therefore, the number of component parts is reduced, and it is possible to increase the operation efficiency to a greater extent.

Further the humidifier 64 configured to humidify the cathode bas by the cathode off gas containing the water may be provided at the supply pipe 52 and the discharge pipe 54 positioned between the fuel cell stack 12 and the expander 98, and the discharge side gas liquid separator 78, 158 may be provided at the discharge pipe 54 on the downstream side of the humidifier 64, and is disposed below the humidifier 64. Therefore, in the piping structure 50 of the fuel cell system 10, 10A, since the discharge side gas liquid separator 78, 158 is disposed below the humidifier 64, it is possible to allow the water in the humidifier 64 to flow into the discharge side gas liquid separator 78, 158 smoothly, by its own weight of the water. That is, it is possible to prevent a large quantity of water from stagnating inside the humidifier 64, and the humidifier 64 can suitably humidify the cathode gas.

Further, preferably, the supply pipe 52 between the humidifier 64 and the fuel cell stack 12 is provided with the supply side gas liquid separator 66 configured to separate water from the cathode gas, and the supply side gas liquid separator 66 is disposed above the expander 98, and includes the water discharge pipe 108 connected to the connector 142 and configured to discharge the separated water into the discharge pipe 54. Also in the structure where the fuel cell system 10 has the supply side gas liquid separator 66, it is possible to allow the water separated through the water discharge pipe 108 to flow into the discharge pipe 54 easily.

Further, the discharge pipe 54 (fourth discharge pipe 88) on downstream side of the expander 98 extends obliquely upward to a curved portion 138 positioned on the upstream side of the connector 142, 164a, and further extends downward obliquely from the curved portion 138 toward the connector 142, 164a. In the structure, it is possible to more reliably prevent the backflow of the water which has flowed from the water discharge pipe 114 into the connector 142, 164a, and operate the expander 98 more stably.

Further, it is preferable that the fuel cell system 10, 10A is mounted in the vehicle 11, the discharge pipe 54 (fourth discharge pipe 88) on the downstream side of the expander 98 extends from the expander 98 toward the rear side of the vehicle 11, and the water discharge pipe 114 extends from the discharge side gas liquid separator 78, 158 toward the rear side of the vehicle 11 (in the direction by the arrow Ar), and is connected to the connector 142, 164a. In the structure, by utilizing the acceleration applied at the time of forward movement of the vehicle 11, it is possible to allow the water to flow rearward, and thus discharge the water more smoothly.

Further, the water discharge pipe 114 is made of the hard pipe 164 fixed to the connector part with the discharge side gas liquid separator 158 and inclined downward. In the structure, the hard pipe 164 can fix the inclination angle of the water discharge pipe 114 for allowing the water in the discharge side gas liquid separator 158 to stably flow obliquely downward. Therefore, it is possible to more reliably suppress backflow of the water from the connector part between the water discharge pipe 114 and the discharge pipe 54 to the expander 98.

It should be noted that the present invention is not limited to the above described embodiments. Various modifications can be made in line with the gist of the present invention. For example, the routes of the supply pipe 52 and the discharge pipe 54 of the cathode gas system apparatus 16 are not limited to the above structure. As long as the water discharge pipe 114 of the discharge side gas liquid separator 78 bypasses the expander 98, the routes can be determined freely. For example, the cathode gas system apparatus 16 may have structure which does not have the supply side gas liquid separator 66.

What is claimed is:

1. A fuel cell system comprising:
a fuel cell stack;
a supply pipe configured to supply a cathode gas to the fuel cell stack;
a discharge pipe configured to discharge a cathode off gas from the fuel cell stack;
an expander connected to the discharge pipe, and configured to expand the cathode off gas; and
a gas liquid separator provided at the discharge pipe positioned between the fuel cell stack and the expander, and configured to separate water from the cathode off gas and discharge the water,
wherein the gas liquid separator is disposed above the expander, and has a water discharge pipe configured to discharge the water; and
the water discharge pipe is connected to a connector part, of the discharge pipe, that is positioned on a downstream side of the expander, and the water discharge pipe extends obliquely downward from the gas liquid separator toward the connector part in a direction away from the expander.

2. The fuel cell system according to claim 1, wherein the discharge pipe between the expander and the gas liquid separator is connected to an upper end of the gas liquid separator.

3. The fuel cell system according to claim 2, wherein a bypass pipe configured to allow the cathode gas to flow from the supply pipe to the discharge pipe is provided between the supply pipe and the discharge pipe; and
the bypass pipe is connected to the gas liquid separator.

4. The fuel cell system according to claim 3, wherein a portion where the supply pipe and the bypass pipe are connected together comprises a unit structural body, and
the unit structural body includes a portion configured to serve as the supply pipe that causes the cathode gas to flow toward the fuel cell stack, and a portion configured to serve as the bypass pipe connected to the gas liquid separator.

5. The fuel cell system according to claim 4, wherein a humidifier is provided at the supply pipe and the discharge pipe positioned between the fuel cell stack and the expander, the humidifier being configured to humidify the cathode gas by the cathode off gas containing the water; and
the gas liquid separator is provided at the discharge pipe on a downstream side of the humidifier, and is disposed below the humidifier.

6. The fuel cell system according to claim 5, wherein the supply pipe between the humidifier and the fuel cell stack is provided with a supply side gas liquid separator configured to separate water from the cathode gas; and
the supply side gas liquid separator is disposed above the expander, and includes a water discharge pipe connected to the connector part and configured to discharge the separated water into the discharge pipe.

7. The fuel cell system according to claim 1, wherein the discharge pipe on a downstream side of the expander extends obliquely upward to a curved portion positioned on an upstream side of the connector part, and further extends obliquely downward from the curved portion toward the connector part.

8. The fuel cell system according to claim 1, wherein the fuel cell system is mounted in a fuel cell vehicle;
the discharge pipe on a downstream side of the expander extends from the expander toward a rear side of the fuel cell vehicle; and
the water discharge pipe extends from the gas liquid separator toward the rear side of the fuel cell vehicle, and is connected to the connector part.

9. The fuel cell system according to claim 1, wherein the water discharge pipe comprises a hard pipe which is fixed to a connector part with the gas liquid separator and inclined downward.
